(19) United States
(12) Patent Application Publication
(10) Pub. No.: US 2007/0168605 A1
(43) Pub. Date: Jul. 19, 2007

(54) Information storage device and its control method

(75) Inventors: Yoriharu Takai, Kodaira-shi (JP); Kenji Yoshida, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/599,362

(22) Filed: Nov. 15, 2006

(30) Foreign Application Priority Data
Jan. 17, 2006 (JP) 2006-009170

(51) Int. Cl. G06F 13/00

(52) U.S. Cl. 711/113

(57) ABSTRACT

According to one embodiment, the device comprises an input part, a disc-shaped storage medium, a non-volatile memory which becomes a cache memory for the disc-shape storage medium, an acquisition part which acquires status information showing the status of the non-volatile memory, and a control part which outputs the status information acquired by the acquisition part based on a status request command input in the input part.

### CROSS-REFERENCE TO RELATED APPLICATIONS

This application is based upon and claims the benefit of priority from Japanese Patent Application No. 2006-009170, filed Jan. 17, 2006, the entire contents of which are incorporated herein by reference.

### BACKGROUND

1. Field

One embodiment of the invention relates to an information storage device and its control method in which information is written in a large-capacity storage medium such as a hard disc using a non-volatile semiconductor memory as a cache.

2. Description of the Related Art

As is well known, in recent years hard discs have seen use as information storage media with high capacity and high reliability, and have spread in many fields for recording, for example, computer data, image data, sound data, etc. Hard discs have also been downsized for mounting in portable electronic equipment.

Therefore, at present, in an information storage device intended for size reduction using the hard disc, it is thought that by using a non-volatile memory capable of rapid recording and rapid reading as a cache memory for the hard disc, speed of recording and reading of information is increased, and by reducing the number of hard disc accesses, that is, the number of times of writing and reading of information on the hard disc, saving of battery power is realized.

In other words, this kind of information storage device makes recording and reading of information to the outside performed by the non-volatile memory and makes the hard disc perform transfer of information between the non-volatile memory, thereby making recording and reading operation viewed from the outside rapid, and the number of times of accessing the hard disc is reduced; thus, it is called a non-volatile (NV)-cache supporting hard disc drive (HDD) and is standardized.

Here, in the information storage device realizing high speed of recording and reading of information as above, and realization of reduction of the number of drive time of the hard disc, use of a flash memory as a non-volatile memory working as a cache is thought.

However, the flash memory has a limit (for example 100,000 times) in the rewritable number of times and has a nature that if that is exceeded, error occurs extremely easily and reliability becomes low.

Therefore, in the information storage device using a non-volatile memory as a cache for the hard disc, it is strongly requested not only to save power by reduction of the number of drive times of the hard disc but also to make an improvement in controlling efficiently recording and reading operation of information taking into consideration that there is a limit in rewritable number of times of non-volatile memory and user-friendliness.

The Jpn. Pat. Appln. Kokai Publication No. 2004-55102 discloses a large capacity storage medium mounting both a memory card and an HDD. This large capacity storage medium is capable of back-up to a hard disc which is a magnetic storage medium, for example, the data of the memory card obtained from the outside and capable of transferring and extracting the data of the hard disc to the memory card.

And the Jpn. Patent No. 3407317 Publication discloses a portable storage device using a flash memory. This Jpn. Patent No. 3407317 Publication provides a data control method so as to suppress increase of rewritable number of times only, for example, in a specific region in order to solve the problem of easy occurrence of errors if the frequency (for example 100,000) of rewriting of the flash memory increases.

### BRIEF DESCRIPTION OF THE SEVERAL VIEWS OF THE DRAWING

A general architecture that implements the various feature of the invention will now be described with reference to the drawings. The drawings and the associated descriptions are provided to illustrate embodiments of the invention and not to limit the scope of the invention.

FIG. 1 shows one embodiment of the invention and is a block diagram showing the outline of the information storage device;

FIG. 2 is an exemplary drawing explaining recording region of a flash memory used in the information storage device in the embodiment;

FIG. 3 is an exemplary drawing explaining the counter of the flash memory interface used in the information storage device in the embodiment;

FIG. 4 is a block diagram explaining one example of a controller used in the information storage device;

FIG. 5 is a block diagram showing one example of a host device connected to the information storage device in the embodiment;

FIG. 6 is a flowchart explaining one example of processing action of the host device in the embodiment;

FIG. 7 is a flowchart explaining one example of processing action of the controller in the embodiment, and

FIG. 8 is a flowchart explaining other example of processing action of the host device in the embodiment.

### DETAILED DESCRIPTION

Various embodiments according to the invention will be described hereinafter with reference to the accompanying drawings. In general, according to one embodiment of the invention, the device comprises an input part, a disc-shaped storage medium, a non-volatile memory which becomes a cache memory for the disc-shape storage medium, an acquisition part which acquires status information showing the status of the non-volatile memory, and a control part which outputs the status information acquired by the acquisition part based on a status request command input in the input part.

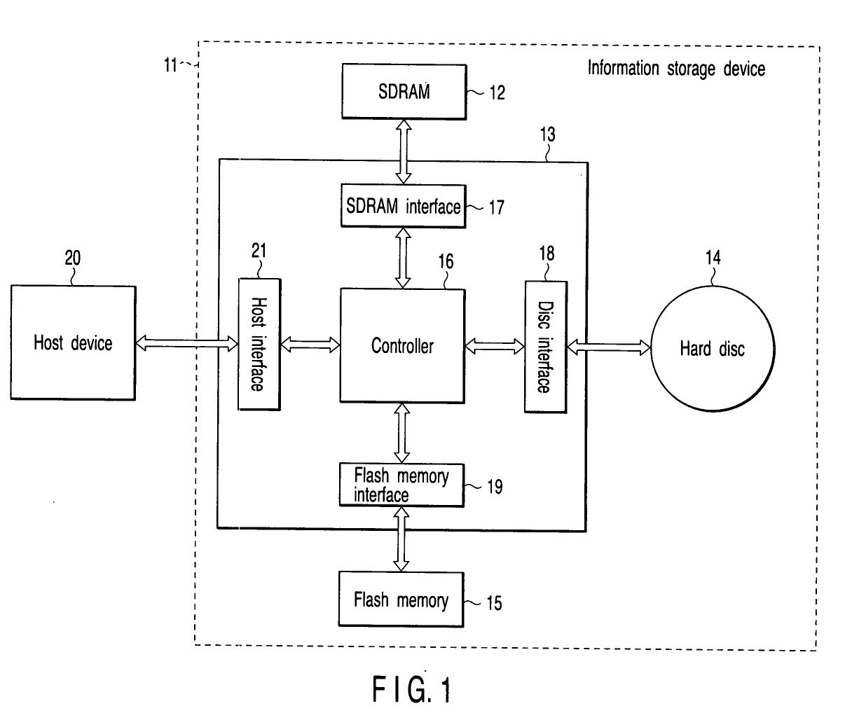

FIG. 1 shows the outline of the information storage device 11 described in this embodiment. The information storage device 11 described here relates to an NV-cache supporting HDD which is standardized by Non-Volatile Cache Command Proposal for ATA8-ACS Revision 5, etc.

That is to say, this information storage device 11 comprises an SDRAM 12 functioning as a buffer, an LSI 13 of one chip building in various kinds of circuit blocks, a hard disc 14 being a disc-shaped storage medium of large capacity, a flash memory 15 or the like being a non-volatile memory functioning as a cache for the hard disc 14.

Out of these, the LSI 13 is mounted with a controller 16 which becomes a control part for performing the general control when the information storage device 11 implements various processing actions. And the LSI 13 is mounted with an SDRAM interface 17 to connect the controller 16 and the above SDRAM 12 capable of information transfer, a disc interface 18 to connect the controller 16 and the above hard disc 14 capable of information transfer, a flash memory interface 19 to connect the controller 16 and the above flash memory 15 capable of information transfer, and a host interface 21, etc. to connect the controller 16 and the external host device 20 capable of information transfer or the like.

Here, the above host device 20 is, for example, a personal computer (PC) or the like. The host device 20 carries out writing and reading of information by using the information storage device 11 when, for example, executing a prescribed application software and can utilize the information storage device 11 as a storage place of the information finally obtained.

In this case, the host device 20 generates a command to request writing of information or a command to request reading out of the information to the information storage device 11. These commands are supplied to the controller 16 through the host interface 21 and analyzed.

Thereby, the controller 16 controls for the SDRAM 12, flash memory 15, hard disc 14, etc., to selectively implement writing of information supplied to the host device 20 and reading of information to the host device 20 or the like. Further, the controller 16 has a function to enable mutual transfer of information between the SDRAM 12, flash memory 15, and hard disc 14.

Basically, the controller 16 makes the flash memory 15 accumulate the writing information, when it receives a request of writing of information from the host device 20. And the controller 16, when, for example, the storage region of the flash memory 15 is used a certain degree or more or the like, transfers the accumulated information in the flash memory 15 to the hard disc 14 and makes it store at a prescribed timing.

The controller 16, when received a request to read information from the host device 20, reads out the requested information from the hard disc 14 and outputs to the host device 20. In this case, if the requested information exists in the flash memory 15, it reads outs the information from the flash memory 15 and outputs to the host device 20.

At this time, an error correction code is added to the information (data) written in the above flash memory 15, and an error correction processing is applied based on the error correction code to the data read out from the flash memory 15.

And also the error correction code is added to the data recorded in the hard disc 14. And error correction processing is applied to the data read out from the hard disc 14 based on the error correction code.

In this embodiment, a method having a much higher error correction capacity is used for the error correction processing applied to the data recorded in the hard disc 14 than the error correction processing applied to the data recorded in the flash memory 15. That is to say, the data recorded in the hard disc 14 has much higher reliability than the data recorded in the flash memory 15.

Also in this embodiment, as an example, the above flash memory 15 is defined to have a writing and reading unit of information as 2K bytes. Further, the flash memory 15 is defined to have an erasing unit of 128K bytes. And when the number of times of writing and reading becomes large, the element of the flash memory 15 is deteriorated, and the rate of occurrence of errors becomes high. Therefore, as the information to guarantee performance of the element, the rewriting number of times is defined as about 100,000.

Hereinafter, various commands established in the above standard and which are usable in the information storage device 11 and are necessary for explaining this embodiment are described. First of all, a first command designates a logical block address (LBA) to write information in the flash memory 15 out of LBAs on the hard disc 14.

And a second command, same as the first command, designates the LBA to write in the flash memory, but at the same time requests to read the information recorded in the LBA from the hard disc 14 and write the read-out information in the flash memory 15.

The abovementioned first and second commands correspond to PI=0 and PI=1 of the “Add LBA(s) to NV Cache Pinned Set” in the above standard and the LBAs instructed by the host device 20 to store information in the flash memory 15 are given an attributed information called “pinned”.

A third command designates an LBA on the hard disc 14 and requests writing of information. When the third command is generated from the host device 20, the controller 16 checks whether or not a pinned attributed information is made to correspond with the LBA requested to be written. And if it corresponds, the controller 16 implements writing in the region of the flash memory 15 corresponding to the LBA requested to be written.

When, on the other hand, the pinned attributed information is not made to correspond with the LBA requested to be written, the controller 16 determines by its own judgment whether or not to write information in a region corresponding to the LBA designated in the flash memory 15 or whether or not to write in the designated LBA in the hard disc 14 and implements writing.

A fourth command designates an LBA in the hard disc 14 and requests reading of information. When the fourth command is generated from the host device 20, the controller 16, if it is judged that a region corresponding to the designated LBA is already allocated in the flash memory 15 and a newer information than that of the hard disc 14 is stored in that region, is required to read out the corresponding information from the flash memory 15.

On the other hand, when there exists same information in both the hard disc 14 and the flash memory 15, the controller 16 may read the information from the region corresponding to the LBA requested to read in the flash memory 15 or read the information from the designated LBA in the hard disc 14.

And when a region corresponding to the designated LBA is already allocated in the flash memory 15, but a newest data exists in the hard disc 14, the controller 16 is required to read the information from the designated LBA of the hard disc 14. And when it reads the information from the hard disc 14, the controller 16 judges whether or not to cache the information to the flash memory 15.

Out of LBAs in which a pinned attributed information is not made to correspond out of the LBA requested writing and reading of information, such as the abovementioned third and fourth commands, the LBAs which are allocated a region in the flash memory 15 and in which information is written on the allocated region on the flash memory 15 are given an attributed information called “unpinned”.

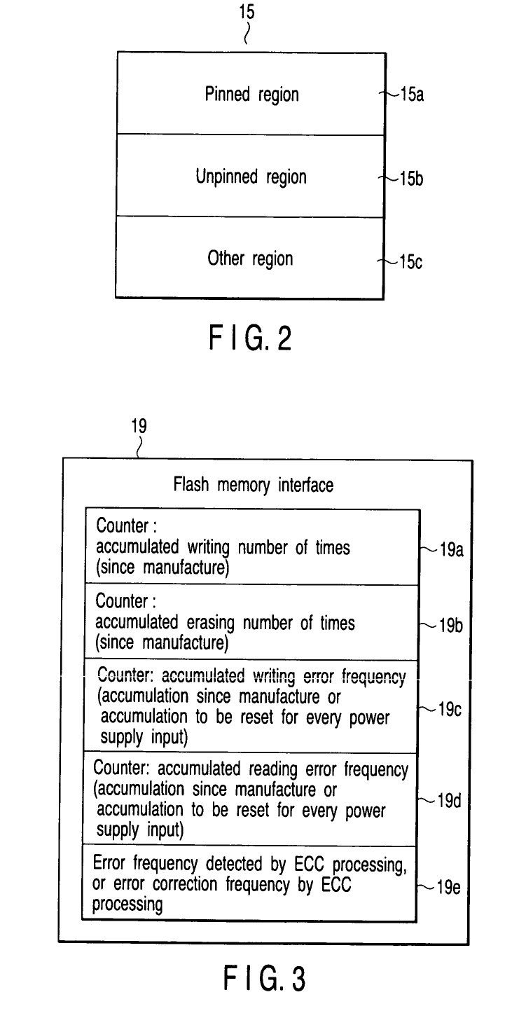

Then, the LBA which is given the pinned attributed information is called a pinned LBA, and the region on the flash memory 15 corresponding to the pinned LBA is called a pinned region. And the LBA which is given the unpinned attributed information is called an unpinned LBA, and the region on the flash memory 15 corresponding to the unpinned LBA is called an unpinned region. Thereby, as is shown in FIG. 2, the pinned region 15a, the unpinned region 15b, and the other region 15c are formed in the flash memory 15.

A fifth command requests to form an empty region for a designated size portion in the flash memory 15. When the fifth command is generated from the host device 20, the controller 16, if the present empty region in the flash memory 15 is smaller than the requested empty region, moves the information of the designated size or more from the unpinned region 15b of the flash memory 15 to the hard disc 14 and secures the empty region of the designated size portion in the flash memory 15. In this case, it is determined by the judgment of the controller 16 which region's information out of the unpinned region 15b in the flash memory 15 is moved to the hard disc, that is to say, in which region of the flash memory 15, the empty region is formed.

Next, the flash memory interface 19 is explained. The flash memory interface 19 has not only a function of connecting the controller 16 and the flash memory 15 capable of information transfer, but also has various counters 19a-19e as is shown in FIG. 3. Each count value of the counters 19a-19e is stored in, for example, a non-volatile memory not shown in the figure but provided in the flash memory interface 19. And it is possible that the flash memory 15 is utilized for storing the count value.

First of all, the counter 19a counts the number of times of writing in accumulation since the manufacture. The counter 19b counts in accumulation the number of times of erasing since the manufacture. The counter 19c counts in accumulation the frequency of writing errors since the manufacture (or as reset for every power supply input). The counter 19d counts in accumulation the frequency of reading errors (or as reset for every power supply input). The counter 19e counts in accumulation the frequency of errors detected by error checking and correcting (ECC) processing or the frequency of error correction by the ECC processing. Based on the count values of these each counters 19a-19e, deterioration status of the flash memory 15 can be judged.

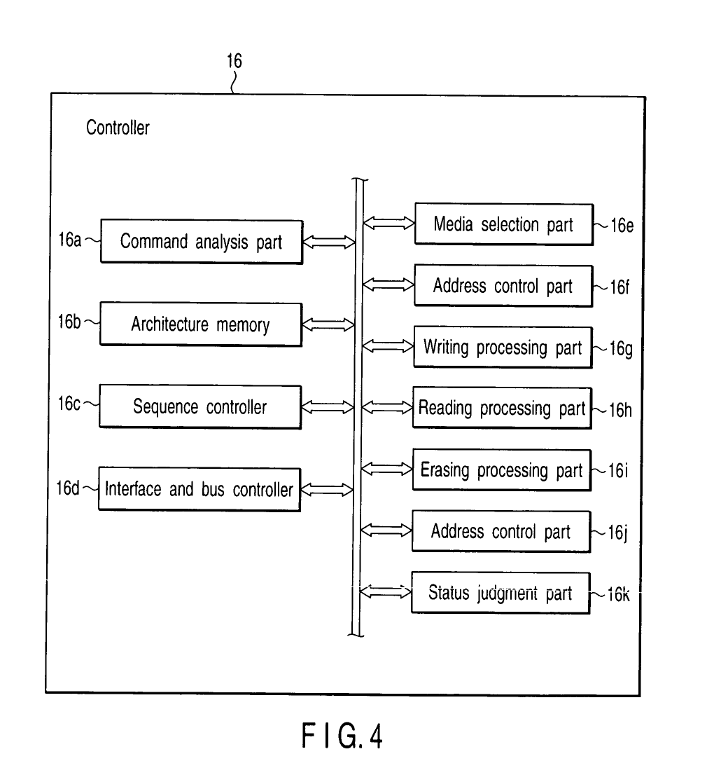

The FIG. 4 shows one example of the controller 16. The controller 16 has a command analysis part 16a which decoding processes and analyzes a command supplied from the host device 20. By the analysis result of this command analysis part 16a, a software in an architecture memory 16b is identified, and an action procedure is established in a sequence controller 16c.

The sequence controller 16c controls the flow of information through an interface and a bus controller 16d. For example, when writing and reading of information are performed, a media selection part 16e identifies the flash memory 15 or the hard disc 14 and an address control part 16f identifies a writing address and a reading address.

At the time of writing of information, a writing processing part 16g carries out transfer process or the like of writing information and at the time of reading of the information, a reading processing part 16h carries out transfer process or the like of the read-out information.

Further, the controller 16 has an erasing processing part 16i. This erasing processing part 16i carries out erasing process of the information recorded in the flash memory 15 and the erasing processing part 16i can also carry out erasing process of the information recorded in the hard disc 14.

The controller 16 has, further, an address control part 16j. The address control part 16j controls in one lot the address of recorded region and non-recorded region or the like of the flash memory 15 and the hard disc 14. Further, a status judgment part 16k for monitoring drive status of the hard disc 14 is provided at the controller 16.

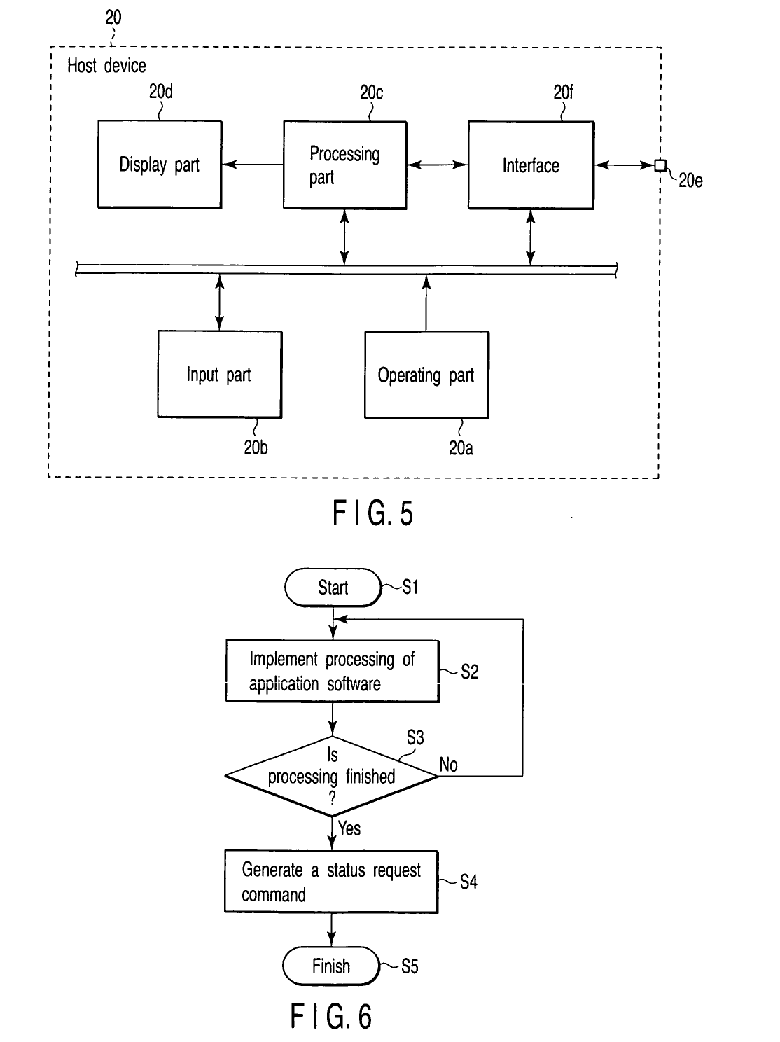

The FIG. 5 shows one example of the host device 20. The host device 20 has an operating part 20a for a user to operate and an input part 20b for obtaining information from an external network and a prescribed information storage medium based on the operation of this operating part 20a.

Further, the host device 20 has a processing part 20c which applies a prescribed signal processing to the information obtained by the input part 20b and generates a command to the information storage device 11 and a display part 20d which displays the processing result of this processing part 20.

Furthermore, the host device 20 has an interface 20f which outputs the information and command being the processing result of the processing part 20c to the outside (information storage device 11) through a connector 20e, and supplies the information inputted from the outside (information storage device 11) through the connector 20e to the processing part 20c.

Now, the flash memory 15, as is described earlier, has a limit (about 100,000 times) in the rewritable number of times and therefore, if access of writing, reading, and erasing, etc., exceeding the limit number of times is made, rate of occurrence of writing errors and probability of occurrence of writing errors and probability of occurrence of ECC errors become high. Further, probability of occurrence of ECC errors becomes high if reading of information to the same recording region is made repeatedly.

However, in the abovementioned standard, a means by which a host device 20 obtains information showing the status of rewriting number of times and erasing number of times is not defined, therefore, the host device 20 cannot judge whether or not the flash memory 15 is physically in the state of being liable to occurrence of errors, and thus there arises a trouble when writing, reading, and erasing of information are made to the information storage device 11.

Therefore, in this embodiment, a status request command by which the host device 20 requests to the information storage device 11 and obtains a status information of the flash memory 15 is established anew.

In this case, the host device 20 can generate a status request command by its own judgment at a prescribed timing. And the controller 16, by receiving the status request command, controls so as to transfer to the host device 20 the information of each counter 19a-19e of the flash memory interface (as described earlier, recorded for example in the flash memory 15) as a status information of the flash memory 15.

FIG. 6 shows one example of processing action in which the host device 20 generates a status request command at a prescribed timing. That is to say, when processing starts (Block S1), the processing part 20c of the host device 20 carries out process of a prescribed application software in Block S2.

Then, the processing part 20c of the host device 20 judges whether or not the process of the application software has been completed in Block S3 and if judged that it is completed (YES), generates a status request command to the information storage device 11 in Block S4, and finishes the process (Block S5).

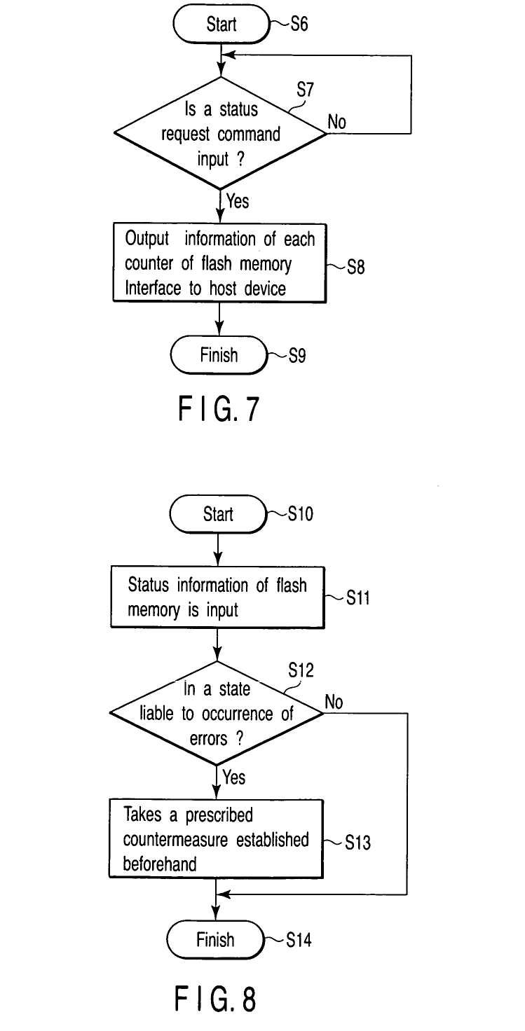

FIG. 7 shows one example of processing action of the controller 16 at the time when it has received a status request command. That is to say, when process starts (Block S6), the controller judges whether or not the status request command is input in Block S7, and when it has judged that the status request command is input (YES), the controller 16 transfers the information of each counter 19a-19e of the flash memory interface 19 to the host device 20 in Block S8 and finishes process (Block S9).

FIG. 8 shows one example of processing action of the host device 20 at the time when it has received a status request information of the flash memory 15. That is to say, when processing starts (Block S10) and the status information of the flash memory 15 is input in Block 11, the processing part 20c judges based on the status information whether or the flash memory 15 is in a state of being liable to occurrence of errors in Block S12.

In this case, judgment on whether the flash memory 15 is in a state of being liable to occurrence of errors is made by comparing the information of each counter 19a-19e of the flash memory interface 19 with the reference values established beforehand.

And when it is judged that the flash memory 15 is in a state of being liable to make errors (YES), the processing part 20c takes a countermeasure established beforehand in Block S13, and completes the processing (Block S14). And when it is judged that the flash memory 15 is not in a state of being liable to make errors (NO), the processing part 20c completes the processing as it is (Block S14).

Here, as a countermeasure in the above Block S13, a method is considered such as that, for example, utilizing the abovementioned fifth command, etc., the information of the flash memory 15 is transferred to the hard disc 14 and migrated, or that the information after the processing completion of the application software is stored in the hard disc 14 through SDRAM 12.

According to the above embodiment, a status request command by which the host device 20 requests to the information storage device 11 and obtains the status information of the flash memory 15 is established anew.

Thereby, the host device 20 can judge, based on the status information obtained, whether or not the flash memory 15 is in a state of being liable to occurrence of errors. And when it is judged that the flash memory is in the state of being liable to make errors, a countermeasure established beforehand can be taken to the information storage device 11. Thereby, the scale of damages of information due to errors of the flash memory 15 can be made small, and countermeasures can be taken so as not to damage reliability of the information as much as possible.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage device comprising: an input part configured to be input with a command, a disc-shaped storage medium, a non-volatile memory configured to become a cache memory for the above disc-shaped storage medium, an acquisition part configured to obtain a status information showing the status of the non-volatile memory, and a control part configured to perform writing information on the non-volatile memory based on a writing command input in the above input part, storing the information recorded in the non-volatile memory in the disc-shaped storage medium at a prescribed timing, and outputting a status information obtained in the above acquisition part based on a status request command input in the input part.

2. An information storage device according to claim 1, wherein the above status information includes any of writing frequency, erasing frequency, writing error frequency, and reading error frequency to the non-volatile memory.

3. An information storage device according to claim 1, wherein the above status information includes error frequency detected by the error correction process to the information read out from the non-volatile memory.

4. An information storage device according to claim 1, wherein the above status information includes error correction frequency to the information read out from the non-volatile memory.

5. An information storage device according to claim 1, wherein the above acquisition part comprises counters configured to count any of writing frequency, erasing frequency, writing error frequency, and reading error frequency to the non-volatile memory.

6. An information storage device according to claim 1, wherein the above disc-shaped storage medium is a hard disc and the above non-volatile memory is a flash memory.

7. A host device comprising: a processing part configured to generate a status request command for requesting the control part to output a status information which the acquisition part has acquired, as for the information storage device having an input part configured to be input with a command, a disc-shaped storage medium, a non-volatile memory configured to become a cache memory for the disc-shaped storage medium, an acquisition part configured to acquire status information showing the status of the non-volatile memory, and a control part configured to perform writing information on the non-volatile memory based on a writing command input in the input part and storing the information recorded in the non-volatile memory in the disc-shaped storage medium at a prescribed timing.

8. A host device according to claim 7, wherein the abovementioned processing part is configured to make a judgment on the status of the non-volatile memory based on a status information supplied from the information storage device in response to the above status request command and take a countermeasure established beforehand according to its judgment result.

9. A host device according to claim 8, wherein the abovementioned processing part is configured to make a judgment on the status of the non-volatile memory comparing the status information with a reference value established beforehand.

10. A control method of an information storage device comprising: a first process in which a command is input, a second process in which information is written on a non-volatile memory which becomes a cache memory for the disc-shaped storage medium based on the writing command input in the first process, a third process in which the information recorded in the above non-volatile memory in the second process is stored in the above disc-shaped storage medium at a prescribed timing, a fourth process in which the status information showing the status of the non-volatile memory is obtained, and a fifth process in which the status information obtained in the fourth process is output based on a status request command input in the first process.

11. A control method of the information storage device according to claim 10, wherein in the above fourth process, the status information is obtained by counting any of the writing frequency, erasing frequency, writing error frequency, and reading error frequency to the non-volatile memory.
